(19) United States
(12) Patent Application Publication
(10) Pub. No.: US 2003/0159153 A1
(43) Pub. Date: Aug. 21, 2003

(54) Method and apparatus for processing ATVEF data to control the display of text and images

(75) Inventors: Barry P. Falvo, Norristown, PA (US); Christopher J. Stone, Newtown, PA (US); Steven A. DiDomenico, Mt. Laurel, NJ (US); Raymond C. Bontempi, Jamison, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: General Instrument Corporation

(21) Appl. No.: 10/081,947

(22) Filed: Feb. 20, 2002

(51) Int. Cl. H04N 7/173

(52) U.S. Cl. 725/110; 725/111; 725/112; 725/113

(57) ABSTRACT

An auxiliary display device is used in conjunction with a cable television (CATV) system to process television content metadata extracted from a transport stream received by a set-top box (STB) and sent to the auxiliary display device. Text and/or images defined by the metadata are presented on a display of the auxiliary display device adjacent to a predefined image (e.g., an advertisement, supplemental data) retrieved from a memory of the auxiliary display device. The predefined image is presented in an area of the display of the auxiliary display device that is designated by the metadata as being reserved for displaying a broadcast television channel video image. The predefined image can be changed on a periodic basis, or in response to the auxiliary display device receiving new metadata from the STB.

### BACKGROUND OF THE INVENTION

1. Field of the Invention

The present invention generally relates to the use and processing of interactive television data for delivering enhanced television programming in a CATV environment.

2. Background Information

The Advanced Television Enhancement Forum (ATVEF) was formed in 1997 by a consortium of 14 leading companies in the television and computing industries. This group developed a public, worldwide specification for creating and delivering interactive TV (ITV) content. In 1999, the ATVEF Specification v1.1, r26 was finalized and published. The ATVEF Specification serves as a standard for creating enhanced, interactive television content and delivering that content to a range of television, set-top, and PC-based receivers. The ATVEF Specification uses existing Internet technologies to deliver enhanced TV programming over both analog and digital video systems using terrestrial, cable, satellite and Internet networks. The ATVEF Specification can be used in both one-way broadcast and two-way video systems, and is designed to be compatible with all international standards for both analog and digital video systems.

Television enhancements are comprised of three related data sources: announcements (delivered via SAP), content (delivered via UHTTP), and triggers (delivered via the trigger protocol over UDP). SAP (Session Announcement Protocol) is a protocol used for session announcements. UHTTP (Unidirectional Hypertext Transfer Protocol) is a simple, robust, one-way resource transfer protocol that is designed to efficiently deliver resource data in a one-way broadcast-only environment. UDP (User Datagram Protocol) is an Internet Standard transport layer connection-less protocol which adds a level of reliability and multiplexing to IP. IP is one of the communication languages used by computers connected to the Internet. This resource transfer protocol is appropriate for Internet Protocol (IP) multicast over a television vertical blanking interval (VBI), IP multicast carried over MPEG, or other unidirectional transport systems. MPEG (Moving Picture Experts Group) is the name of a family of standards used for coding audio-visual information (e.g., movies, video, music) in a digital compressed format. The major advantage of MPEG compared to other video and audio coding formats is that MPEG files are much smaller for the same quality. This is because MPEG uses very sophisticated compression techniques.

In 1953, the NTSC (National Television Standards Committee) developed a set of standard protocols for television (TV) broadcast transmission and reception for use in the United States. An NTSC TV image has 525 horizontal lines per frame (complete screen image). These lines are scanned from left to right, and from top to bottom. Every other line is skipped. Thus, it takes two screen scans to complete a frame, one scan for the odd-numbered horizontal lines, and another scan for the even-numbered lines. Each half-frame screen scan takes approximately 1/60 of a second. A complete frame is scanned every 1/30 second. Each time the electron gun in the television's cathode ray tube finishes scanning a half-frame, it must return to the upper left hand corner of the television screen to prepare for the next half-frame. This takes a significant amount of time, so each pass of the electron gun must be synchronized with the incoming signal. This is done by adding a set of unused lines of data (exactly 21 lines) to the end of each screen scan, giving the electron gun time to return to its starting position. These 21 extra lines make up the VBI. The VBI of a television signal is a non-viewable portion of the television signal that can be used to provide point-to-multipoint IP data services and relieve congestion and traffic in the traditional Internet access networks. IP datagrams may be transmitted using the VBI of a television signal.

Only the first nine lines of the VBI are actually required to reposition the cathode ray. This leaves twelve more lines (10 through 21) that can be used to broadcast data. In the United States, closed captioning data is broadcast on VBI line 21. The transmission of multicast-IP using the North American Basic Teletext Standard (NABTS) is a recognized and industry-supported method of transporting data on the VBI. NABTS has traditionally been used on 525 line television systems such as NTSC.

The ATVEF Specification defines how ATVEF content is displayed and how the receiver is notified of new content. The ATVEF Specification also defines how content is delivered. Since a television or set-top terminal does not necessarily have a connection out to the Internet, the ATVEF Specification describes two distinct models for delivering content. These two content delivery models are commonly referred to as transports, and the two transports defined by ATVEF are referred to as transport type A and transport type B.

Transport type A is defined for ATVEF receivers that maintain a connection (commonly called a back-channel or return path) to the Internet. Transport A is for delivery of triggers by the forward path and the pulling of data by a (required) return path. Generally, this network connection is provided by a dial-up modem, but may be any type of bi-directional access channel. Transport type A is a method for delivering only triggers without additional content. Since there is no content delivered with Transport type A, all data must be obtained over the back-channel, using URLs passed with the triggers as a pointer to the content. ATVEF triggers are broadcast in line 21 of the VBI.

Transport type B provides for delivery of both ATVEF triggers and its associated content via the broadcast network. In this model, the broadcaster pushes content to a receiver, which will store it in the event that the user chooses to view it. Transport B uses announcements sent over the network to associate triggers with content streams. An announcement describes a content stream, and may include information regarding bandwidth, storage requirements, and language (enhancements may be delivered in multiple languages). Transport Type B uses VBI lines 10 through 20 to carry interactive television information, such as IP datagrams.

Thus, with the advent of ATVEF and digital cable TV, a new era in TV viewing experience is emerging in which video complementary data services are available to the TV viewer. There are many potential methods for experiencing these data services. One such way is to use a second display screen on an auxiliary display device. One example of an auxiliary display device is a webpad, which is a relatively small remote wireless device.

Auxiliary display devices are Internet compatible appliances that process and display ATVEF data. The auxiliary display devices are often required to display broadcast television channel video images in a designated area of the screen on the auxiliary display devices. The broadcast television channel video image is normally referred to for obtaining image map data, which defines how ATVEF data and broadcast television channel video images are to be displayed. Under certain circumstances, some auxiliary display devices are unable to access to the video image. Thus, an area of the screen designated for the broadcast television channel video image may not be available for use.

### SUMMARY OF THE INVENTION

In today's cable television market, subscribers are provided with the opportunity to access enhanced video services. Typically, these enhancements include some type of television content metadata and/or IP/World Wide Web information transmitted by a video service provider to a set-top box (STB). The viewer is then allowed to select this metadata (enhanced information) using an auxiliary display device. The same auxiliary display device is used to control the selection of programming viewed on a television. The content metadata is displayed on a display of the auxiliary display device. The present invention enables an alternative predefined image (e.g., an advertisement or an image selected by a user of the auxiliary display device) to be displayed in an area of the display of the auxiliary display device reserved for the broadcast television channel video image. The present invention establishes more control over what is displayed on the auxiliary display device. The present invention may be implemented by Internet appliances, cable/satellite television access control protocols, or any auxiliary display devices equipped with a web browser.

In a preferred embodiment of the present invention, television content metadata is processed in a communications system that includes a set-top box (STB) and an auxiliary display device. The auxiliary display device includes a memory, a display, a processor and a metadata processing application. The memory stores a predefined image. The STB extracts television content metadata from a transport stream received by the STB. The extracted metadata defines at least one of text and images. The extracted metadata is transmitted from the STB to the auxiliary display device. The extracted metadata is processed in the STB using the metadata processing application running on the processor of the auxiliary display device. The predefined image stored in the memory of the auxiliary display device, and the at least one of text and images defined by the extracted metadata are adjacently displayed on the display of the auxiliary display device.

The memory of the auxiliary display device may store a plurality of predefined images. The metadata processing application of the auxiliary display device may change the displayed predefined image on a periodic basis. The extracted metadata may include a uniform resource identifier (URI). The metadata processing application of the auxiliary display device may change the displayed predefined image each time the auxiliary display device receives a URI from the STB. The extracted metadata may further include a uniform resource identifier (URI) that specifies a particular area on the display of the auxiliary display device for a broadcast television channel video image to be presented. The metadata processing application of the auxiliary display device may replace the URI with another URI stored in the memory of the auxiliary display device. The extracted metadata may specify a format for displaying at least one of images and text on the display of the auxiliary display device. The metadata processing application of the auxiliary display device may change the format specified by the extracted metadata. The predefined image may be an advertisement. The extracted metadata may be advanced television enhancement forum (ATVEF) data. The transport stream may include a plurality of vertical blanking interval (VBI) lines. The metadata may be extracted from at least one of the VBI lines. The transport stream may be a Moving Picture Experts Group (MPEG) transport stream. The extracted metadata may be stored, and then be transmitted to the auxiliary display device at a later time in response to playing back the stored metadata.

### BRIEF DESCRIPTION OF THE DRAWINGS

The following detailed description of preferred embodiments of the present invention would be better understood when read in conjunction with the appended drawings. For the purpose of illustrating the present invention, there are shown in the drawings embodiments which are presently preferred. However, the present invention is not limited to the precise arrangements and instrumentalities shown. In the drawings:

FIG. 1A is a block diagram of a communications system operating in accordance with the present invention;

FIG. 1B shows how display space is allocated for presenting text and/or images, and an alternate predefined image, in the communications system of FIG. 1A;

FIG. 2 shows a packet configuration for the forwarding of vertical blanking interval (VBI) line 21 ATVEF data in accordance with the present invention;

FIG. 3 shows an IP datagram reassembled from NABTS packets transported in the VBI in accordance with the present invention;

FIG. 4 shows an IP datagram reassembled from MPEG transport packets in accordance with the present invention;

FIG. 5 is a data flow diagram of an ATVEF VBI line 21 process implemented in accordance with the present invention;

FIG. 6 is a data flow diagram of an ATVEF VBI lines 10 through 21 process implemented in accordance with the present invention;

FIG. 7 is a data flow diagram of an ATVEF over MPEG process wherein ATVEF content is displayed on the display of an auxiliary display device in accordance with the present invention;

FIG. 8 is a data flow diagram of an ATVEF over MPEG process wherein ATVEF content is displayed on a television screen in accordance with the present invention;

FIG. 9 is a data flow diagram of an IP over MPEG process (data service) in accordance with an alternate embodiment of the present invention; and

FIG. 10 is a high-level functional flowchart including steps implemented by the communications system of FIGS. 1A and 1B.

### DETAILED DESCRIPTION OF THE INVENTION

The present invention provides a video entertainment service subscriber with the capability of directing enhanced content (television content metadata) to a device other than the primary receiver (e.g., a television).

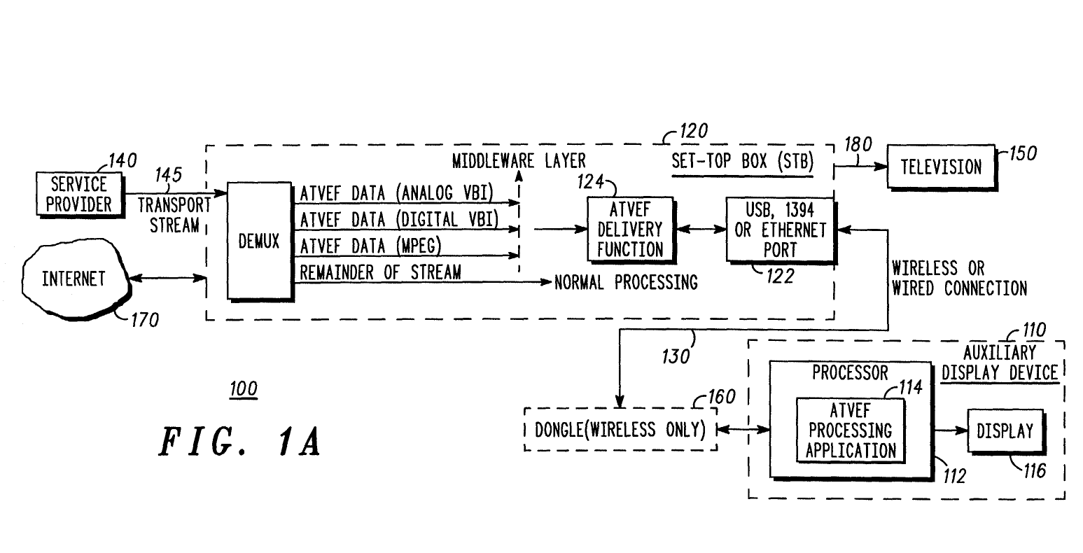

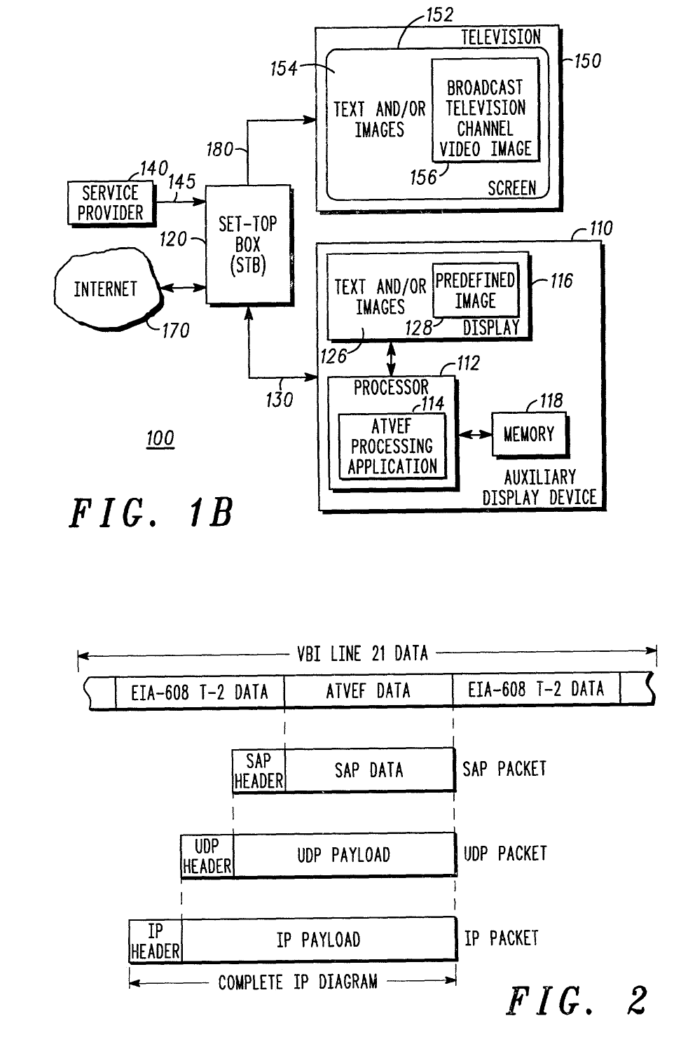

FIG. 1A shows a communications system 100 including an auxiliary display device 110 that communicates with an STB 120 via path 130. The auxiliary display device 110 includes a processor 112 which executes a television content metadata (e.g., ATVEF) processing application 114. The auxiliary display device 110 also includes a display 116. STB 120 is used by a subscriber of video services from service provider 140. Content provided by service provider 140 is presented on television 150 via STB 120 and path 180. Path 130 may be a wired or wireless connection. The wireless connection utilizes an external port 122 of STB 120, such as a universal serial bus (USB), Ethernet, or IEEE 1394 port equipped with a dongle 160 (e.g., a wireless local area network (WLAN)). A dongle is a device used for ensuring that only authorized users can copy or use specific software applications. Dongle 160 is used to support wireless connectivity between STB 120 and auxiliary display device 110. The auxiliary display device 110 may access Internet 170 via STB 120. The auxiliary display device 110 may also be connected directly to a high-speed cable modem, digital subscriber (DSL) modem or any other high-speed Internet connection device to access the Internet 170. The wireless connection could be either HomeRF® or IEEE 802.11. A more traditional wired connection would simply include a cable or wire between STB 120 and auxiliary display device 110, again, using a USB, Ethernet, or IEEE 1394 port.

The STB 120 includes an ATVEF delivery function 124 which receives enhanced content/metadata from service provider 140 via a transport stream 145. ATVEF delivery function 124 is configured to perform the following functions:

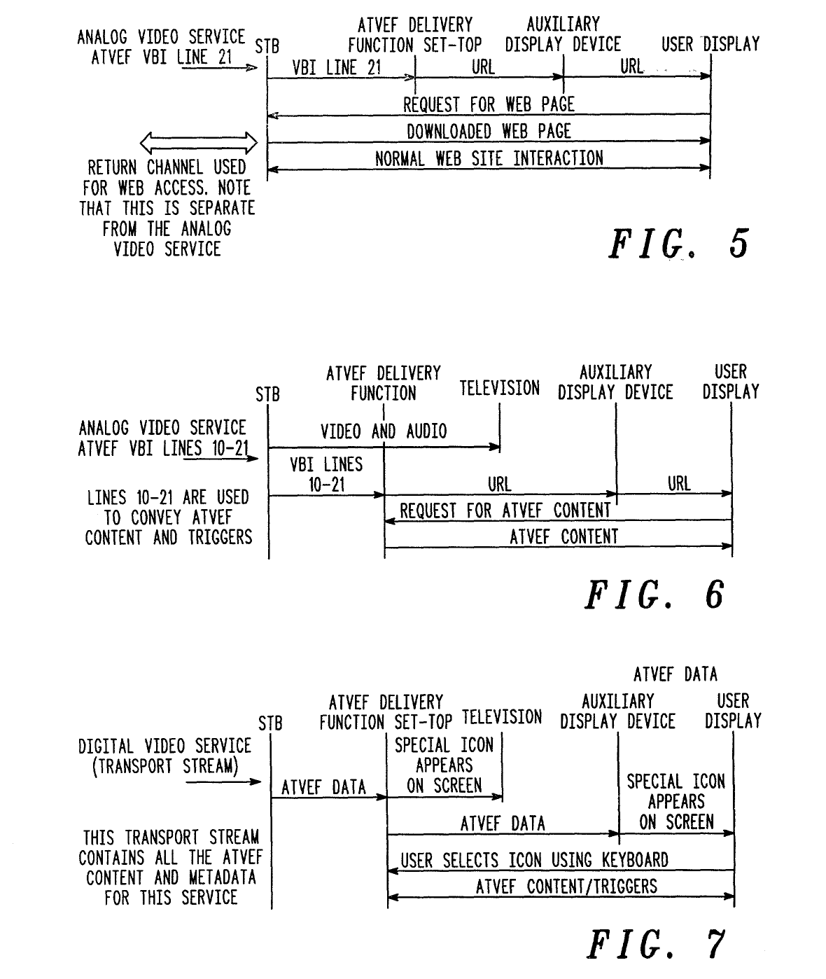

(1) Pass-through all ATVEF data to the auxiliary display device 110 for processing (analog ATVEF, VBI line 21 data, and VBI lines 10 through 21 data) (see FIGS. 5 and 6);

(2) Pass-through content and triggers to the auxiliary display device 110 for processing (ATVEF over MPEG) (see FIG. 7);

(3) Selectively process certain ATVEF and television content metadata locally for display on the television 150, before passing through the remaining data to the auxiliary display device 110 (see FIG. 8); and

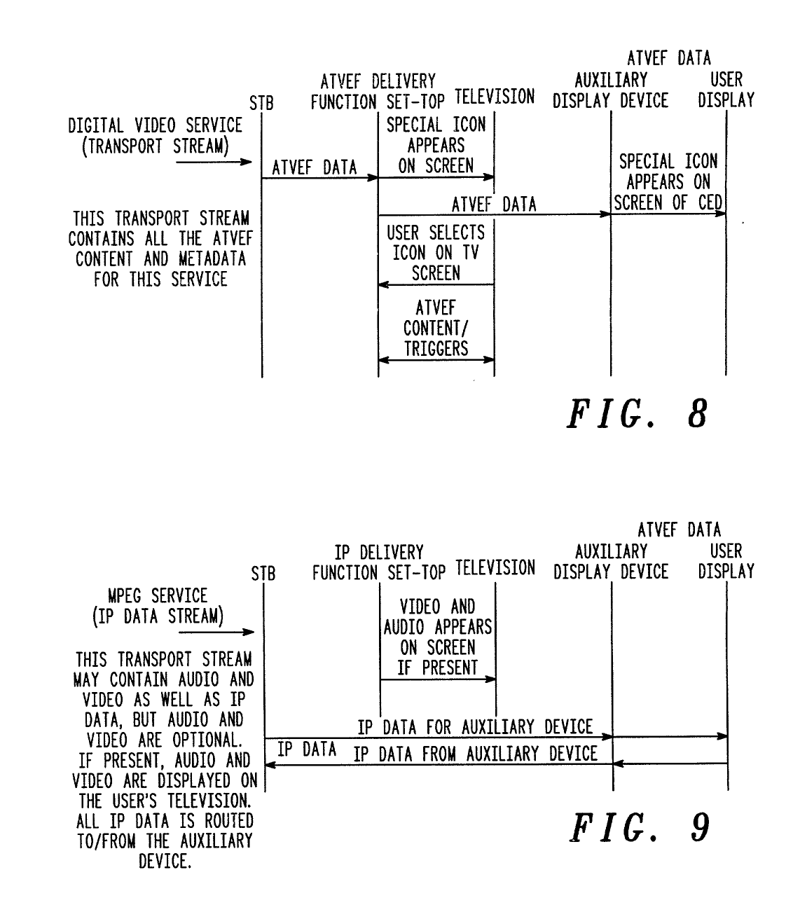

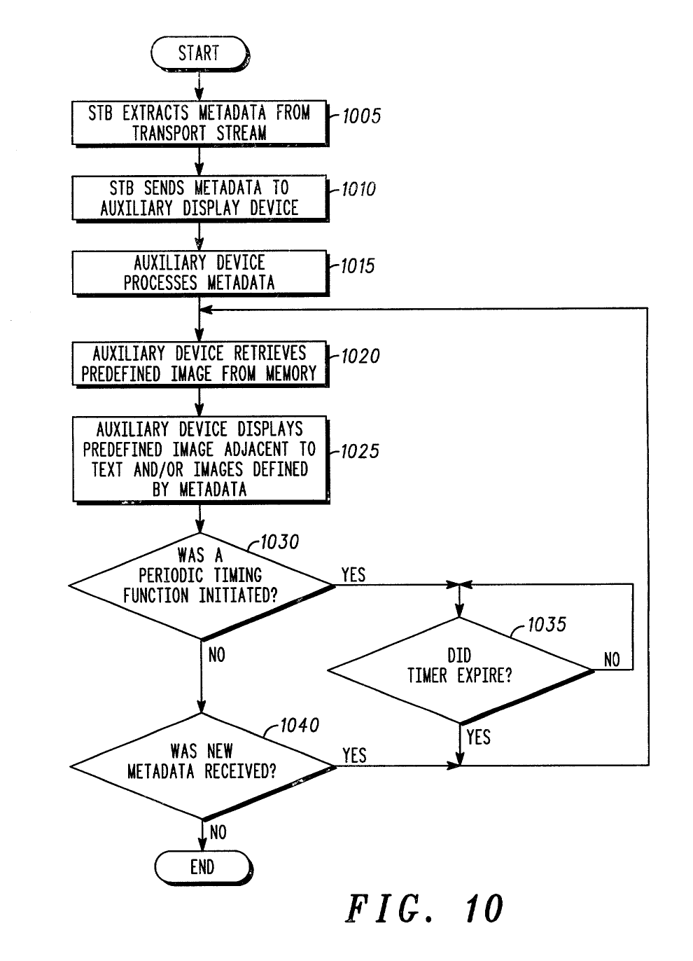

(4) For the processing of a primary data service, displaying optional video and audio content, when present, on television 150 or the auxiliary display device 110 such that all data is routed to the auxiliary display device 110 for processing (see FIG. 9).

FIG. 1B shows how television content metadata extracted from transport stream 145 is used to configure text and/or images on a screen 152 of television 150 and the display 116 of auxiliary display device 110. The television content metadata includes a uniform resource identifier (URI) that requires that a broadcast television channel video image be presented in a designated location. For example, the television 150, which has access to the video image, displays the broadcast television channel video image at location 156 on screen 152. At the same time, text and/or other images may be displayed at location 154 on screen 152 of television 150. The auxiliary display device 110, which does not have access to the video image, displays a predefined image at location 128 on display 116 of the auxiliary display device 110. The same text and/or images shown at location 154 on screen 152 of television 150 may also be shown at location 126 on display 116 of the auxiliary display device 110. The predefined image may either be obtained from a memory 118 within the auxiliary display device 110 that was loaded during the manufacture of the auxiliary display device 110, or accessed from a remote site, such as Internet 170. The display of the predefined image can be dependent on an algorithm running on processor 112 within the auxiliary display device 110. For example, the predefined image may change each time a new “tv:” URL is received by the auxiliary display device 110 from STB 120. In another example, the memory may store a plurality of predetermined images. The predefined image displayed on the auxiliary display device 110 may be changed on a periodic basis (e.g., every 30 seconds) using a timing mechanism (not shown). Any display area defined hyperlinks that are specified by the extracted metadata are remapped to either the predefined image, or some other presentable format.

The auxiliary display device 110 presents the predefined image in an area of display 116 designated by the metadata as being reserved for a broadcast television channel video image. The predefined image may be an advertisement. The television 150 presents a broadcast television channel video image adjacent to the text and/or images defined by the metadata. The URI may be a uniform resource locator (URL) used to launch a web page that provides display location data that specifies how the text and/or images defined by the metadata, and the predefined image, are to be presented on the display 116 of the auxiliary display device 110. The auxiliary display device 110 may convert the URI into a different URI, using conventional correlation techniques.

A toggle function can be incorporated into the STB 120 and/or auxiliary display device 110 to allow a user to select whether metadata extracted from transport stream 145 should be processed by television 150, assuming it has an ATVEF or other metadata processing application running within, or by the auxiliary display device 110. Alternatively, the extracted metadata can be stored by a personal video recorder (PVR), and transmitted from the STB 120 to the auxiliary display device 110 at a later time when the stored metadata is played back by the PVR. The PVR can be incorporated into STB 120 or it can be configured as an independent device that communicates with STB 120. The metadata can also be stored in the STB 120, in another auxiliary device (e.g., an external hard drive), or in a remote server. An authoring mechanism and application programming interface (API) set may be incorporated into system 100 to enable a content creator to determine what content is to be viewed on television 150 and/or the auxiliary display device 110.

A key functionality of the ATVEF Delivery Function 124 of STB 120 is the packetization of raw ATVEF content metadata received from transport stream 145 on VBI line 21. The ATVEF content metadata is carried on VBI line 21 using a Text-2 (T-2) service. The ATVEF content metadata is configured to include at least one uniform resource locator (URL). The ATVEF content metadata is extracted from the VBI via the ATVEF Delivery Function 124. Once extracted, the ATVEF Delivery Function 124 will verify that the metadata is ATVEF.

The ATVEF metadata defines text and/or images displayed on the auxiliary display device 110 and/or the television 150. The images may include static video images, full 30 frames per second MPEG-2 video, or the like. The ATVEF metadata may also define audio, animation (e.g., Flash™, Shockwave®, or the like), video clip or any other type of media that can be presented from Internet content.

FIG. 2 shows how VBI line 21 metadata is processed by the ATVEF Delivery Function 124 of STB 120 by constructing a packet to forward the VBI line 21 data. If the metadata is ATVEF, then the ATVEF Delivery Function 124 encapsulates the metadata into a SAP packet. The ATVEF Delivery Function 124 then encapsulates the SAP packet into a UDP/IP packet that is assigned a multicast IP and a UDP destination port. The ATVEF Delivery Function then transmits a UDP/IP datagram via port 122 of STB 120.

FIG. 3 shows how IP ATVEF data received on VBI lines 10 through 20 is processed by the ATVEF Delivery Function 124 of STB 120 by packetizing IP ATVEF data in the form of NABTS packets. ATVEF data that is carried in IP over VBI is extracted from VBI lines 10 through 20 via the ATVEF Delivery Function 124, reconstructed into serial line Internet protocol (SLIP) packets, encapsulated into UDP/IP packets and passed to the port 122 of STB 120.

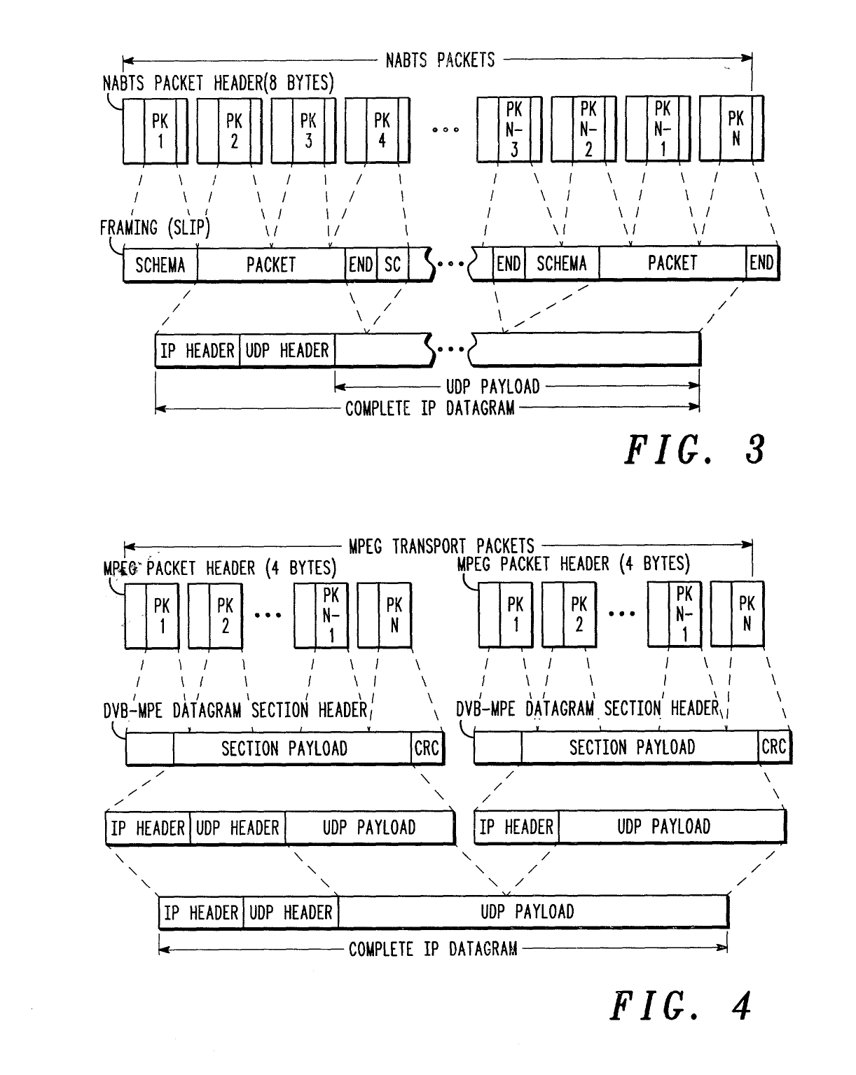

FIG. 4 shows how IP ATVEF data received on the MPEG transport stream is processed by the ATVEF Delivery Function 124 by packetizing IP ATVEF in the form of MPEG Transport packets. ATVEF data that is carried in IP over MPEG is extracted from the MPEG transport stream via the ATVEF Delivery Function 124, reconstructed into digital video broadcasting multi-protocol encapsulation (DVB-MPE) packets, encapsulated into UDP/IP packets and passed to the port 122 of STB 120.

FIG. 5 shows an embodiment of the present invention wherein analog ATVEF data including at least one uniform resource identifier (URI) is extracted from VBI line 21 in the STB 120 and forwarded for processing in the auxiliary display device 110. A URI identifies any metadata resource. The URI may be a uniform resource locator (URL) which locates a metadata resource of the World Wide Web. In this example, the ATVEF processing function in the STB 120 is configured for pass-through capability only, and the STB 120 does not process any ATVEF data locally. Video and audio for this service is displayed to the user's television 150. For analog ATVEF, the URI contained in VBI line 21 is sent to the auxiliary display device 110 and presented on display 116 to the user. Here, a return channel is used by the auxiliary display device 110 to access actual content.

FIG. 6 shows another embodiment of the present invention wherein VBI lines 10 through 21 are used in an analog video service to convey ATVEF announcements, content and triggers. The analog video and audio are routed to the user's television 150, and ATVEF data is routed to the auxiliary display device 110. Optionally, ATVEF data may be processed internally on the STB 120 for presentation on the user's television 150. In this example, however, the display 116 of the auxiliary display device 110 is used for the presentation of enhanced content.

FIG. 7 shows yet another embodiment of the present invention wherein the user has tuned to an enhanced digital video service that contains both content and triggers. In this embodiment, the ATVEF Delivery function 124 in the STB 120 is configured differently than in the analog ATVEF case. No separate return channel is required to retrieve content, since all content is present in the video service multiplex. Once the service is tuned, an icon is displayed on both the television 150 and the display 116 of the auxiliary display device 110 to inform the user that this is an enhanced service. Using a keyboard (not shown) on the auxiliary display device 110, the user selects the icon on the display 116 of the auxiliary display device 110, causing all content and trigger information to be sent directly to the auxiliary display device 110 for processing and display. Normal video and audio continues to be displayed to the television 150.

FIG. 8 shows yet another embodiment of the present invention wherein the user can select the icon displayed on the television 150, in which case all content and triggers are processed internally by the ATVEF delivery function 124 in the STB 120 for display on the user's television 150.

FIG. 9 shows yet another embodiment of the present invention wherein a data service may optionally contain video and audio. If present, the STB 120 routes the video and audio to the user's television 150 by default. All metadata is routed directly to the auxiliary display device 110. Data may optionally be selectively routed to the television 150, at the discretion of the user.

FIG. 10 shows how the preferred embodiment of the present invention is implemented in communications system 100. In step 1005, the STB 120 extracts television content metadata from transport stream 145 received by the STB 120. The extracted metadata defines at least one of text and images. In step 1010, the extracted metadata is transmitted from the STB 120 to the auxiliary display device 110. Alternatively, the extracted metadata is stored, and then transmitted to the auxiliary display device 110 at a later time when the stored metadata is played back. In step 1015, the metadata processing application 114 running on the processor 112 of the auxiliary display device 110 is used to process the extracted metadata received from STB 120. In step 1020, the auxiliary display device 110 retrieves a predefined image from memory 118. In step 1025, the predefined image 128 is displayed adjacent to the at least one of text and images 126 defined by the extracted metadata on display 116 of the auxiliary display device 110. Alternatively, the predefined image may be accessed from a remote site or other source, such as from Internet 170. In step 1030, a determination is made as to whether an optional periodic timing function is to be initiated by the metadata processing application 114, whereby the memory 118 stores a plurality of predefined images and the displayed predefined image is changed on a periodic basis (e.g., every 30 seconds). If the optional periodic timing function is implemented, and a predetermined time period elapses (step 1035), the auxiliary display device 110 retrieves a different predefined image from memory 118 as instructed by the metadata processing application 114 (step 1020). Furthermore, if the auxiliary display device 110 receives new metadata from STB 120 (step 1040), the auxiliary display device 110 will retrieve a different predefined image from memory 118 (step 1020).

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method of processing television content metadata in a communications system, the system including a set-top box (STB) and an auxiliary display device, the auxiliary display device including (i) a memory which stores a predefined image, (ii) a display, (iii) a processor, and (iv) a metadata processing application, the method comprising:
(a) the STB extracting television content metadata from a transport stream received by the STB, the extracted metadata defining at least one of text and images;
(b) transmitting the extracted metadata from the STB to the auxiliary display device;
(c) processing the extracted metadata in the auxiliary display device using the metadata processing application running on the processor of the auxiliary display device; and
(d) adjacently displaying on the display of the auxiliary display device (i) the predefined image stored in the memory of the auxiliary display device, and (ii) the at least one of text and images defined by the extracted metadata.

2. The method of claim 1 wherein the memory of the auxiliary display device stores a plurality of predefined images, the method further comprising:
(e) the metadata processing application of the auxiliary display device changing the displayed predefined image on a periodic basis.

3. The method of claim 2 wherein the extracted metadata includes a uniform resource identifier (URI), the method further comprising:
(f) the metadata processing application of the auxiliary display device changing the displayed predefined image each time the auxiliary display device receives a URI from the STB.

4. The method of claim 1 wherein the extracted metadata further includes a uniform resource identifier (URI) that specifies a particular area on the display of the auxiliary display device for a broadcast television channel video image to be presented, the method further comprising:
(e) the metadata processing application of the auxiliary display device replacing the URI with another URI stored in the memory of the auxiliary display device.

5. The method of claim 1 wherein the extracted metadata specifies a format for displaying at least one of images and text on the display of the auxiliary display device, the method further comprising:
(e) the metadata processing application of the auxiliary display device changing the format specified by the extracted metadata.

6. The method of claim 1 wherein the predefined image is an advertisement.

7. The method of claim 1 wherein the extracted metadata is advanced television enhancement forum (ATVEF) data.

8. The method of claim 1 wherein the transport stream includes a plurality of vertical blanking interval (VBI) lines, and the metadata is extracted from at least one of the VBI lines.

9. The method of claim 1 wherein the transport stream is a Moving Picture Experts Group (MPEG) transport stream.

10. The method of claim 1 wherein step (a) further comprises storing the extracted metadata, and step (b) is implemented in response to playing back the stored metadata.

11. A communications system for processing television content metadata, the system comprising:
(a) a set-top box (STB) which extracts television content metadata from a transport stream received by the STB, the extracted metadata defining at least one of text and images; and
(b) an auxiliary display device in communication with the STB, and which receives the extracted metadata from the STB, the auxiliary display device including:
(i) a memory which stores a predefined image;
(ii) a processor;
(iii) a metadata processing application running on the processor, and which processes the extracted metadata; and
(iv) a display which displays the predefined image adjacent to the at least one of text and images defined by the extracted metadata.

12. The system of claim 11 wherein the memory of the auxiliary display device stores a plurality of predefined images, and the metadata processing application of the auxiliary display device changes the displayed predefined image on a periodic basis.

13. The system of claim 12 wherein the extracted metadata includes a uniform resource identifier (URI), and the metadata processing application of the auxiliary display device changes the displayed predefined image each time the auxiliary display device receives a URI from the STB.

14. The system of claim 11 wherein the metadata processing application of the auxiliary display device replaces a first uniform resource identifier (URI) included in the extracted metadata with a second URI stored in the memory of the auxiliary display device, the first URI specifying a particular area on the display of the auxiliary display device for a broadcast television channel video image to be presented.

15. The system of claim 11 wherein the metadata processing application of the auxiliary display device changes a format specified by the extracted metadata for displaying at least one of images and text on the display of the auxiliary display device.

16. The system of claim 11 wherein the predefined image is an advertisement.

17. The system of claim 11 wherein the extracted metadata is advanced television enhancement forum (ATVEF) data.

18. The system of claim 11 wherein the transport stream includes a plurality of vertical blanking interval (VBI) lines, and the metadata is extracted from at least one of the VBI lines.

19. The system of claim 11 wherein the transport stream is a Moving Picture Experts Group (MPEG) transport stream.

20. The system of claim 11 wherein the communications system is a cable television (CATV) system.

21. An auxiliary display device for processing television content metadata, the auxiliary display device receiving television content metadata extracted from a transport stream, the extracted metadata defining at least one of text and images, the auxiliary display device comprising:
(a) a memory which stores a predefined image;
(b) a processor;
(c) a metadata processing application running on the processor, and which processes the extracted metadata; and
(d) a display which displays the predefined image adjacent to the at least one of text and images defined by the extracted metadata.

22. The device of claim 21 wherein the memory stores a plurality of predefined images, and the metadata processing application changes the displayed predefined image on a periodic basis.

23. The device of claim 22 wherein the extracted metadata includes a uniform resource identifier (URI), and the metadata processing application changes the displayed predefined image each time the auxiliary display device receives a URI.

24. The device of claim 21 wherein the metadata processing application replaces a first uniform resource identifier (URI) included in the extracted metadata with a second URI stored in the memory, the first URI specifying a particular area on the display for a broadcast television channel video image to be presented.

25. The device of claim 21 wherein the metadata processing application changes the format specified by the extracted metadata for displaying at least one of images and text on the display of the auxiliary display device.

26. The device of claim 21 wherein the predefined image is an advertisement.
